(19) United States
(12) Patent Application Publication
(10) Pub. No.: US 2021/0243156 A1
(43) Pub. Date: Aug. 5, 2021

(54) Method for Securing OpenRAN Interfaces

(71) Applicant: Parallel Wireless, Inc., Nashua, NH (US)

(72) Inventors: Rajesh Kumar Mishra, Westford, MA (US); William Matthew Rowe, Dover, MA (US)

(21) Appl. No.: 17/164,835

(22) Filed: Feb. 1, 2021

Related U.S. Application Data
(60) Provisional application No. 62/968,814, filed on Jan. 31, 2020.

(51) Int. Cl. H04L 29/06; H04L 29/12; H04L 12/803

(52) U.S. Cl. CPC H04L 63/0209; H04L 63/0254; H04L 47/125; H04L 61/256

(57) ABSTRACT

Systems, methods, and computer software are disclosed for securing OpenRAN Interfaces. In ne embodiment a method is disclosed, comprising placing a stateful firewall at a node between a base station and a core network; wherein the stateful firewall mitigates compromised traffic from a radio access network (RAN).

### CROSS-REFERENCE TO RELATED APPLICATIONS

This application claims priority under 35 U.S.C. § 119(e) to U.S. Provisional Pat. App. No. 62/968,814, filed Jan. 31, 2020, titled “Method for Securing OpenRAN Interfaces” which is hereby incorporated by reference in its entirety for all purposes. This application hereby incorporates by reference, for all purposes, each of the following U.S. patent application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety. Features and characteristics of and pertaining to the systems and methods described in the present disclosure, including details of the multi-RAT nodes and the gateway described herein, are provided in the documents incorporated by reference.

### BACKGROUND

Virtual RAN is a potential new architecture for cellular networks. In some embodiments of this architecture, a split is defined between a distributed unit (DU) and a centralized unit (CU) with a main goal to break the strong coupling of software and hardware design per standard. Moreover, 5G adaptation depends on the flexibility required for software modifications combined with even stronger requirement to keep/lower DU hardware installation/upgrade cost. In other words, the Virtual-RAN architecture can be defined such that DU hardware upgrades will be limited to not required during the evolution of 5G while digital baseband (BB) design, including Modem part, will be easily changeable by software upgrade. Such flexibility is achievable since the DU should run on a computationally strong centralized platform.

Various definitions of Virtual RAN entail several split options between the PHY/RF layers to the upper layers. The main differences between the split options are the required data rates and latency limitations, where higher data rates will be needed when the split is done closer to the RF. To ease the challenging requirement for high data rates between the RU and DU, several split options have been suggested inside the PHY/Modem. Such options divide the PHY layer to upper PHY (implemented at the DU) and lower PHY (implemented at the RU). Additional split option defined between the PHY and MAC layers. Splitting the PHY to upper and lower PHY seems to be the most beneficial alternative since it's well balancing the required data rates between the RU and DU as well as providing more flexibility for future modifications.

### SUMMARY

In modern cellular operator networks, it is important to balance management capability with security. Previously (see, e.g., U.S. Pat. Pub. No. US20190075484A1 Mishra et al, hereby incorporated by reference in its entirety), a stateful firewall has been considered. A stateful firewall can be used to identify unwanted, compromised, or dangerous traffic on the network. The stateful firewall can be placed at various parts of the network; typically a stateful firewall is placed in the core network. It is also understood that network address translation (NAT) can be used in the core network, and that NAT provides some benefit of isolating nodes from attackers outside a particular subnet. However, at the present time nobody is thinking about security on RU/CU/DU (radio unit/centralized unit/distributed unit) and other interfaces commonly known as OpenRAN. On the CU (BBU), it is advantageous to design using a common processor, for example, Intel's Xeon CPUs. Those types of CPUs can communicate with common PC interfaces such as Ethernet but cannot accept direct signaling of high-speed serial protocols such as CPRI. To overcome this issue, additional FPGA/HW accelerator is required to convert CPRI (or equivalent) communication into Ethernet (or equivalent) communication as a bridge between the DU “language” and the CU “language”. Those kinds of protocol conversion FPGA/HW accelerators are costly and considered as burden to the vRAN deployment, as well as potentially sources of security issues in a trusted multi-vendor environment.

Methods for securing OpenRAN Interfaces are described. In one embodiment the method includes placing a stateful firewall at a node between a base station and a core network; wherein the stateful firewall mitigates compromised traffic from a radio access network (RAN).

In another embodiment a non-transitory computer-readable medium contains instructions for securing OpenRAN Interfaces, which, when executed, cause a system to perform steps including operating a stateful firewall placed at a node between a base station and a core network; wherein the stateful firewall mitigates compromised traffic from a radio access network (RAN).

In another embodiment a system securing OpenRAN Interfaces includes a base station; a core network; a node between the base station and the core network and in communication with the base station and a core network; and wherein the node includes a stateful firewall mitigates compromised traffic from a radio access network (RAN).

### BRIEF DESCRIPTION OF THE DRAWINGS

FIG. 1 is a diagram showing different split options, in accordance with some embodiments.

FIG. 2 is a diagram showing different split options and the processing blocks they include, in accordance with some embodiments.

FIG. 3 is a diagram showing a system including one or more stateful firewalls, in accordance with some embodiments.

FIG. 4 is a diagram showing a another system including one or more stateful firewalls, in accordance with some embodiments.

FIG. 5 is a schematic network architecture diagram for 3G and other-G prior art networks.

FIG. 6 is an enhanced eNodeB for performing the methods described herein, in accordance with some embodiments.

FIG. 7 is a coordinating server for providing services and performing methods as described herein, in accordance with some embodiments.

### DETAILED DESCRIPTION

Virtual RAN is a potential new architecture for cellular networks. In some embodiments of this architecture, a split is defined between a distributed unit (DU) and a centralized unit (CU) with a main goal to break the strong coupling of software and hardware design per standard. Moreover, 5G adaptation depends on the flexibility required for software modifications combined with even stronger requirement to keep/lower DU hardware installation/upgrade cost. In other words, the Virtual-RAN architecture can be defined such that DU hardware upgrades will be limited to not required during the evolution of 5G while digital baseband (BB) design, including Modem part, will be easily changeable by software upgrade. Such flexibility is achievable since the DU should run on a computationally strong centralized platform.

Various definitions of Virtual RAN entail several split options between the PHY/RF layers to the upper layers. The main differences between the split options are the required data rates and latency limitations, where, higher data rates will be needed when the split is done closer to the RF. To ease the challenging requirement for high data rates between the DU and CU, few split options were suggested inside the PHY/Modem. Such options divide the PHY layer to upper PHY (implemented at the CU) and lower PHY (implemented at the DU). Additional split option defined between the PHY and MAC layers. Splitting the PHY to upper and lower PHY seems to be the most beneficial alternative since it's well balancing the required data rates between the CU and DU as well as providing more flexibility for future modifications.

In modern cellular operator networks, it is important to balance management capability with security. Previously (see, e.g., U.S. Pat. Pub. No. US20190075484A1 Mishra et al, hereby incorporated by reference in its entirety), a stateful firewall has been considered. A stateful firewall can be used to identify unwanted, compromised, or dangerous traffic on the network. The stateful firewall can be placed at various parts of the network; typically a stateful firewall is placed in the core network. It is also understood that network address translation (NAT) can be used in the core network, and that NAT provides some benefit of isolating nodes from attackers outside a particular subnet. However, at the present time nobody is thinking about security on RU/CU/DU (radio unit/centralized unit/distributed unit) and other interfaces commonly known as OpenRAN. On the CU (BBU), it is advantageous to design using a common processor, for example, Intel's Xeon CPUs. Those types of CPUs can communicate with common PC interfaces such as Ethernet but cannot accept direct signaling of high-speed serial protocols such as CPRI. To overcome this issue, additional FPGA/HW accelerator is required to convert CPRI (or equivalent) communication into Ethernet (or equivalent) communication as a bridge between the DU “language” and the CU “language”. Those kinds of protocol conversion FPGA/HW accelerators are costly and considered as burden to the vRAN deployment.

Split Options Overview

In this section we describe the split options alternatives as proposed by 3GPP. It is worth noting that the 3GPP has its own security architecture; however, the present disclosure is viewed as complementary to or additive to the 3GPP security architecture and can extend the 3GPP security architecture in ways particularly useful for a multi-manufacturer OpenRAN ecosystem.

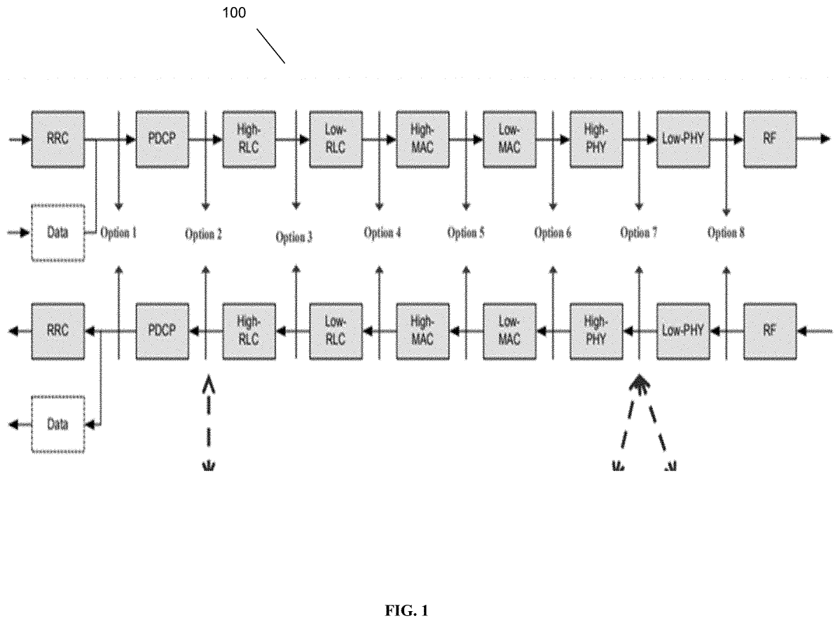

Referring to FIG. 1, split options 1 to 8 100 are presented.

Split option 8 defines a split at the ADC output and DAC input. This option is the most demanding one in terms of data rate and latency.

Split option 7 defines a split within the PHY layer and will be discussed below.

Split option 6 defines a split between the PHY and the MAC which is considered relatively easy to implement and doesn't require high data rates compared to split options 7 and 8.

Other options presented in the figure above won't be discussed at this time since those splits are technology dependent and less of an interest.

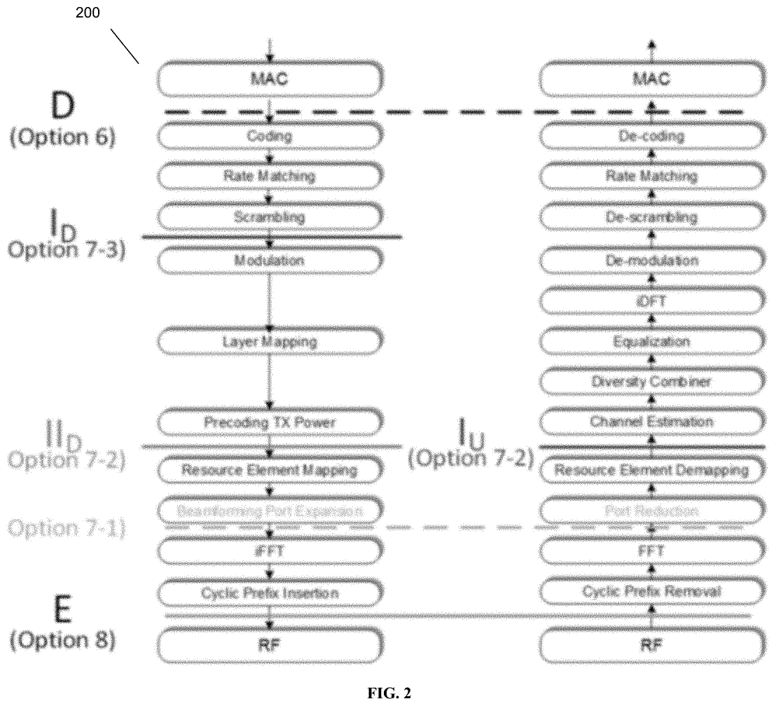

FIG. 2 shows split option 7 200 divided into sub-options as depicted below:

Split option 7.1 defines a split between the time-domain and frequency domains of the PHY. This option serves well the concept of easily changing the frequency domain implementation at the CU.

Split option 7.2 includes the RE mapping and the beamforming handling on top of Split option 7.1. The main benefit of this option is the data rate relaxation (compared to option 7.1) required by the beamforming block.

Split option 7.3 defines a split at the modulation block. It may or may not include the scrambling block.

The inventors have appreciated that it is possible to mitigate compromised or dangerous traffic from the radio access network (RAN) by placing a stateful firewall in the RAN. Network address translation can be provided at the stateful firewall. Specifically, the stateful firewall can be placed at a node between the base station and the core network, such as a management node or controller node; or, at a centralized unit (CU) in a case of a CU/DU split; or, at the base station itself. In some embodiments, the stateful firewall can perform aggregation and brokering. In some embodiments, the stateful firewall can be placed at both ends of a CU/DU split. In some embodiments, if the radio is compromised, we can mitigate that by detecting compromised or dangerous traffic at the stateful firewall. Interoperability and safety is therefore enhanced by this architecture.

In some embodiments, the inventors have appreciated the following alternatives and enhancements. Wherever a stateful firewall is described herein, a stateless firewall could also be used, with the advantage of added speed, albeit with, e.g., less opportunity to interwork. Any arbitrary split between any of the layers shown in FIG. 1, e.g., Option 6, Option 7, Option 7.1, Option 7.2, Option 8, etc., could enable the use of an interface or protocol, preferably open but alternatively proprietary, for communicating between the devices on either side of the split, and a firewall that is put in place between the devices on either side of the split that is configured to validate and/or filter traffic using the known interface, with the interface being appropriately designed to provide functionality appropriate to the given split. Specifically, any RU/DU/CU split interface can be used to design an appropriate firewall that allows only messages that comply with a specified messaging protocol to pass through the firewall. One or more firewalls may be present, in some embodiments. Firewalls may be enabled to be stateless for additional speed and bandwidth, in some embodiments, particularly if useful for being used to transmit high-bandwidth radio frame data.

The inventors have appreciated that since typically, the interfaces use internet protocol (IP) now, which enlarges the applicability of IP-based technologies such as stateful firewalls, but also increases the risk that a malicious actor can hack a device using IP. Suppose a radio has some malicious payload. In some embodiments, a BBU with stateful firewall software is able to prevent that because it acts as a gateway and can act as a stateful firewall. In some embodiments, the stateful firewall makes sure non-meaningful outbound traffic will be blocked. Traffic can be monitored between DU and RU, or when we disaggregate RU to CU/DU, we can say, if DU gets hacked, we can act as a stateful firewall for the DU. It is also important to appreciate that the introduction of this firewall into your network topology effectively introduces a firewall between the RRH and the rest of your network.

In some embodiments, the stateful firewall would be on the upstream. For example, think about Main router of your home Internet can have a firewall. Comcast has its own firewall. Comcast may terminate its traffic at a Verizon aggregation site—and VZ may have its own firewall. Analogously, each node of our RAN system could have a stateful firewall, to protect against threats.

In some embodiments, a controller and aggregator, for example of femto cells or Wi-Fi APs that are coupled to a cellular network or other telecommunication network, can act as a stateful firewall for that also. Security gateway can include a stateful firewall. Any stateful firewall techniques known in the art could be used, in some embodiments.

Using the stateful firewall, the inventors have appreciated that we can make sure the packets you are observing make sense for that protocol and that protocol only. Stateful inspection can be used, including shallow and deep packet inspection, as well as inspection over multiple protocols or protocol layers in the stack. We can leverage accelerators, such as Xeon AVX, FPGA, DSP. Inline processing can be used.

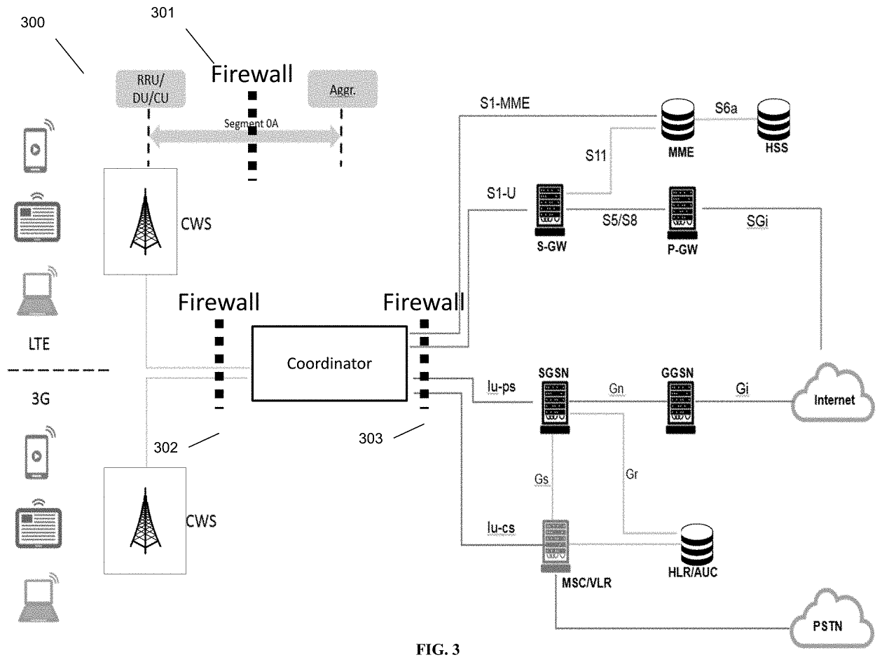

FIG. 3 shows system 300 having a first stateful firewall 301, a second stateful firewall 302 and a third stateful firewall 303. For communication between radio units, e.g., CU/DU, one commonly used protocol is eCPRI. In some embodiments, various splits towards the radio and various splits toward the CU can be monitored using a stateful firewall that uses CPRI/eCPRI protocol monitoring. CPRI is timing+payload+management channel, packetized. The stateful firewall and gateway could perform all these functions and also route these packets through us. We could intercept anything, e.g., a dangerous software upgrade from a bad actor.

In some embodiments, control or data could be monitored by a stateful firewall, as well as 2G, 3G, 4G, 5G traffic, and beyond. In some embodiments, network sharing/MOCN can be significantly enhanced because network sharing requires that hardware be shared among operators; the use of the present invention allows for hardware to be shared more securely due to security monitoring, and by limiting actual traffic exposure from one operator to another operator as well using the firewall/gateway/NAT, not just security. Similarly, for radio sharing (two operators), we can segregate two good guys from each other, not just bad guys.

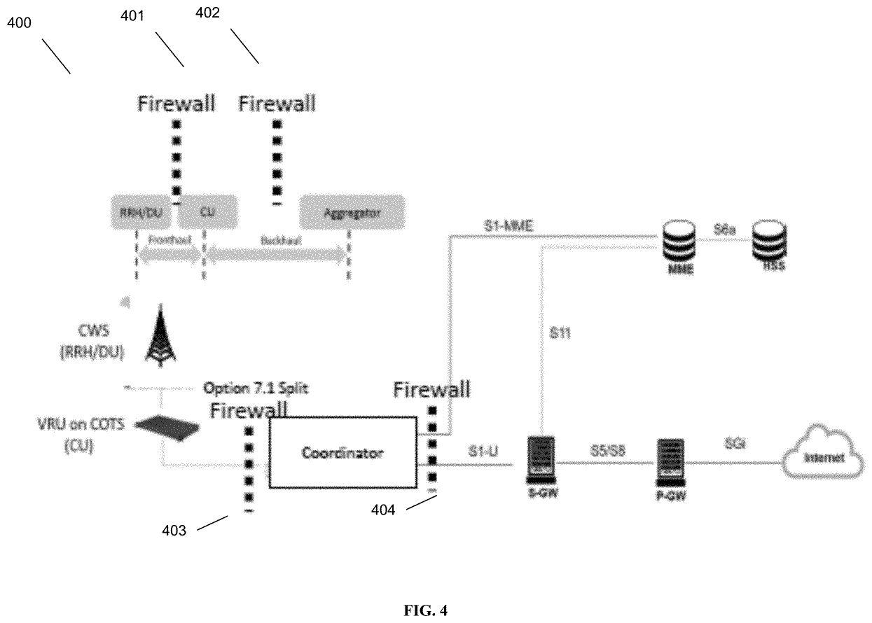

FIG. 4 shows system 400 having a first stateful firewall 401, a second stateful firewall 402, a third stateful firewall 403 and a fourth stateful firewall 404. In some embodiments, multi-operator radio access networks (MORANs) can be turned on by configuration, either locally or remotely. Option to be checked by configurator. Firewall would be enabled in a controller, CU/DU/RU. In some embodiments, threat detection could be shared upstream to a network operator's network operations control room (NOC). The inventors have recognized that in many respects 2G and 3G signals are different, but have similar properties and are treated the same for the purposes of the present disclosure and one of skill in the art would be able to implement the ideas found herein for both 2G and 3G waveforms. Note that the firewalls described herein are limited only by their specific location in the network, and may be useful for 2G and 3G systems as well as for 4G and 5G systems.

The inventors have recognized that, as many 4G technologies are being used directly or in slightly modified form for 5G, the present ideas may be variously embodied in 3G/5G systems, 4G/5G systems, 2G/3G/4G/5G systems in any combination, etc., using the equivalent implementation of the present ideas and disclosures in 5G as for 4G. Some of the modes used for 5G are well based on LTE and hence as well it's possible to run 5G over LTE PHY (split options 7.1, 7.2, 7.3, 8 at least). Running 2G/3G/4G over 5G radio is possible and hence we must add it to the patent. To clarify, where the present disclosure describes 2G/3G over 4G PHY, we should add 2G/3G/4G over 5G PHY.

In some embodiments a network node may use a different split for 4G than for 5G, so that 2G and 3G may be provided separately from the same network node or cell using a different split, e.g., 2G is provided using a 4G node with an Option 7.1 split while 3G is provided using a 5G node, etc. In the case where 4G and 5G are both available, either at the same device or different devices, the present disclosure contemplates the use of 2G/3G waveforms over either 4G or 5G as appropriate.

In some embodiments, optimizations are contemplated between 2G/3G and 4G/5G since they are being carried by the same waveform and are potentially generated by the same hardware and/or software.

In some embodiments, a computing device providing a firewall may provide the firewall as software on a server, which may be in the form of a physical server or alternatively in the form of virtual machines or containers (e.g., Linux containers or Docker containers). In the case of a virtual machine or containerized deployment, the firewall may accept inbound network traffic and may output outbound network traffic via one or more virtual network interface, and configuration of the firewall may be performed using a container orchestration architecture and technology such as, e.g., Kubernetes, thereby allowing simple and rapid deployment of firewalls throughout the network from a central control server. If using virtual network interfaces, buffering may allow these firewalls to be put into place without requiring downtime from the network node on either side of the firewall.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, LTE-compatible networks, to UMTS-compatible networks, or to networks for additional protocols that utilize radio frequency data transmission. Various components in the devices described herein may be added, removed, or substituted with those having the same or similar functionality. Various steps as described in the figures and specification may be added or removed from the processes described herein, and the steps described may be performed in an alternative order, consistent with the spirit of the invention.

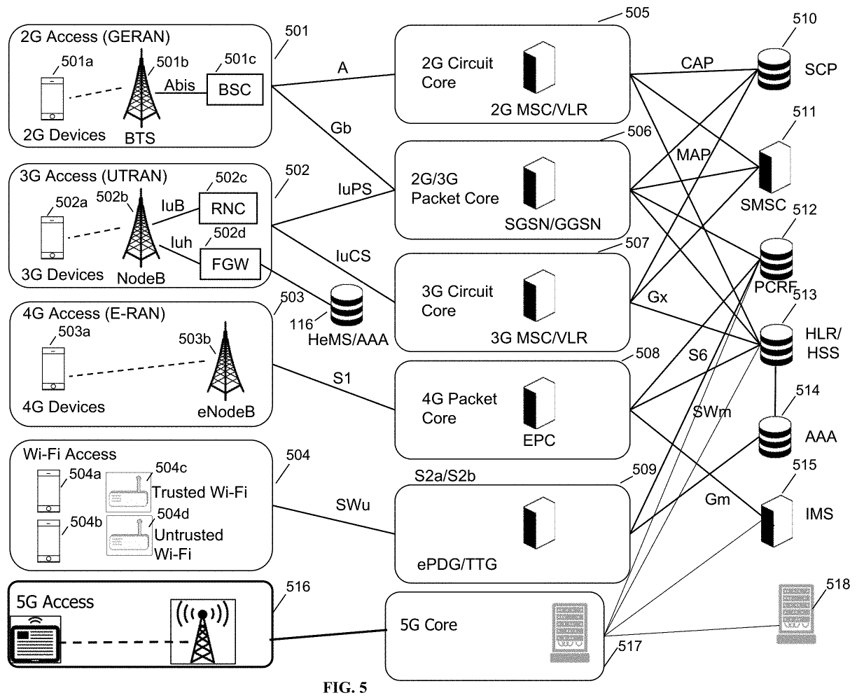

FIG. 5 is a schematic network architecture diagram for 3G and other-G prior art networks. The diagram shows a plurality of “Gs,” including 2G, 3G, 4G, 5G and Wi-Fi. 2G is represented by GERAN 101, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

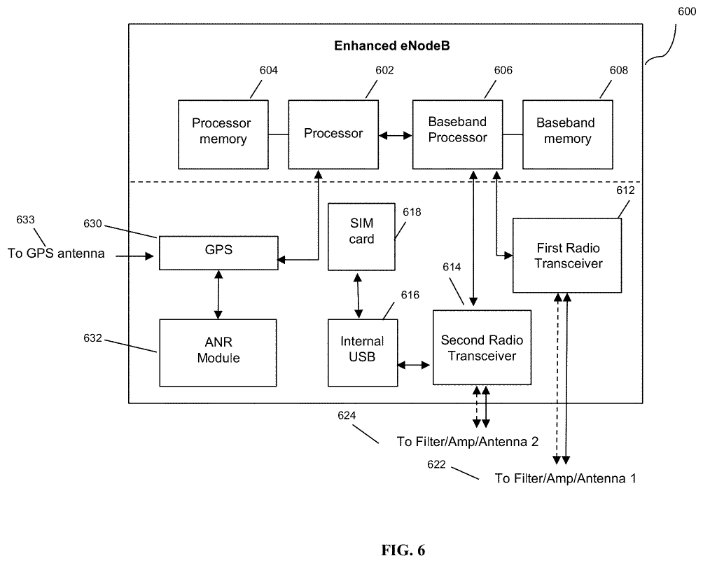

FIG. 6 is an enhanced eNodeB for performing the methods described herein, in accordance with some embodiments. Mesh network node 600 may include processor 602, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

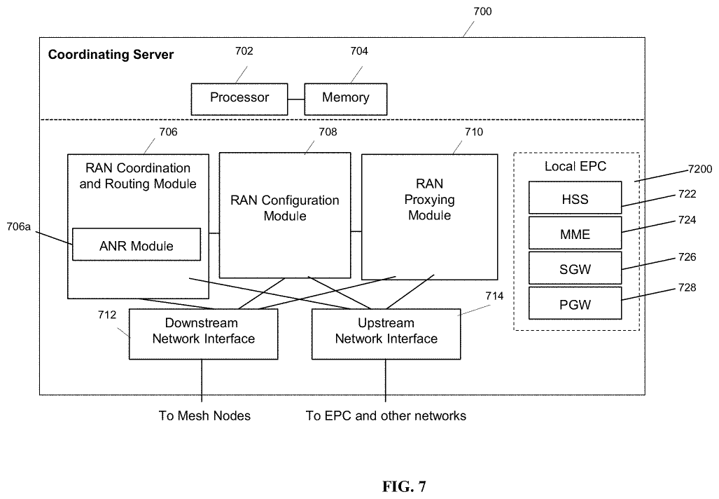

FIG. 7 is a coordinating server for providing services and performing methods as described herein, in accordance with some embodiments. Coordinating server 700 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a may perform the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 may coordinate multiple RANs using coordination module 706. In some embodiments, coordination server may also provide proxying, routing virtualization and RAN virtualization, via modules 710 and 708. In some embodiments, a downstream network interface 712 is provided for interfacing with the RANs, which may be a radio interface (e.g., LTE), and an upstream network interface 714 is provided for interfacing with the core network, which may be either a radio interface (e.g., LTE) or a wired interface (e.g., Ethernet).

Coordinator 700 includes local evolved packet core (EPC) module 720, for authenticating users, storing, and caching priority profile information, and performing other EPC-dependent functions when no backhaul link is available. Local EPC 720 may include local HSS 722, local MME 724, local SGW 726, and local PGW 728, as well as other modules. Local EPC 720 may incorporate these modules as software modules, processes, or containers. Local EPC 720 may alternatively incorporate these modules as a small number of monolithic software processes. Modules 706, 708, 710 and local EPC 720 may each run on processor 702 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access, or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for securing OpenRAN Interfaces, comprising:
placing a stateful firewall at a node between a base station and a core network;
wherein the stateful firewall mitigates compromised traffic from a radio access network (RAN).

2. The method of claim 1 further comprising performing network address translation (NAT) at the stateful firewall.

3. The method of claim 1 wherein placing a stateful firewall at a node between a base station and a core network comprises placing the stateful firewall at a management node.

4. The method of claim 1 wherein placing a stateful firewall at a node between a base station and a core network comprises placing the stateful firewall at a controller node.

5. The method of claim 1 wherein placing a stateful firewall at a node between a base station and a core network comprises placing the stateful firewall at a centralized unit (CU) in a case of a CU/DU split.

6. The method of claim 1 wherein placing a stateful firewall at a node between a base station and a core network comprises placing the stateful firewall at the base station itself.

7. The method of claim 1 further comprising performing aggregation and brokering.

8. The method of claim 1 wherein placing a stateful firewall at a node between a base station and a core network comprises placing the stateful firewall at both ends of a CU/DU split.

9. The method of claim 1 further comprising the stateful firewall blocking non-meaningful outbound traffic.

10. A non-transitory computer-readable medium containing instructions for securing OpenRAN Interfaces, which, when executed, cause a system to perform steps comprising:
operating a stateful firewall placed at a node between a base station and a core network; wherein the stateful firewall mitigates compromised traffic from a radio access network (RAN).

11. The computer-readable medium of claim 10 further comprising instructions for performing network address translation (NAT) at the stateful firewall.

12. The computer-readable medium of claim 10 further comprising instructions for performing aggregation and brokering.

13. The computer-readable medium of claim 10 further comprising instructions for blocking non-meaningful outbound traffic.

14. A system securing OpenRAN Interfaces, comprising:
a base station;
a core network;
a node between the base station and the core network and in communication with the base station and a core network; and
wherein the node includes a stateful firewall mitigates compromised traffic from a radio access network (RAN).

15. The system of claim 14 the stateful firewall performs network address translation (NAT).

16. The system of claim 14 wherein the stateful firewall is placed at a management node or at a controller node.

17. The system of claim 14 wherein the stateful firewall is placed at a centralized unit (CU) in a case of a CU/DU split.

18. The system of claim 14 wherein the stateful firewall is placed at the base station itself.

19. The system of claim 14 wherein the stateful firewall is placed at both ends of a CU/DU split.

20. The system of claim 14 wherein the stateful firewall blocks non-meaningful outbound traffic.
